(19) United States
(12) Patent Application Publication
(10) Pub. No.: US 2002/0013933 A1
(43) Pub. Date: Jan. 31, 2002

(54) Graphic data conversion method and its apparatus

(75) Inventor: Hisashi Shiba, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/863,453

(22) Filed: May 24, 2001

(30) Foreign Application Priority Data
May 26, 2000 (JP) 2000-156579

(51) Int. Cl. G06F 17/50

(52) U.S. Cl. 716/4; 345/420; 345/423; 345/630

(57) ABSTRACT

Graphic data conversion method and graphic data conversion apparatus enable appropriate graphic data for a fault inspection equipment to be provided, in which unprepared increase of data-volume is avoided even when CAD data of a graphic form drawing equipment is made to convert into graphic data for the fault inspection equipment, and it is prevented that processing speed of the fault inspection equipment decreases caused by unnecessary region division. Graphic data whose region is divided among the CAD data is made to unify for generating graphic data which represents the whole original graphic form. Thereafter, the optimum graphic data for the fault inspection equipment is made to fleshly generate from the aforementioned graphic data in such a way as to match division-region that is determined by a file format of the fault inspection equipment. For that reason, unprepared division of the graphic data is avoided within the division-region that is determined by the file format for the fault inspection equipment. Thus, it is possible to prevent increase of data caused by unnecessary division of the graphic format and it is possible to prevent delay of processing operation of the fault inspection equipment that utilizes such data.

### BACKGROUND OF THE INVENTION

1. Field of the Invention

The present invention relates to graphic data conversion method and its apparatus; and more to particularly the present invention relates to improvement of graphic data conversion method and graphic data conversion apparatus in which CAD data for a graphic form drawing equipment formed in such a way as to divide a region of the data is made to convert into graphic data for a fault inspection equipment.

2. Description of Related Art

CAD data for the graphic form drawing equipment is formed in such a way as to divide the region of the data. The CAD data for the graphic form drawing equipment is made to convert into graphic data for the fault inspection equipment. A picture data is obtained in such a way as to measure the manufactures by the fault inspection equipment. Comparison is made between the picture data and the graphic data thus converted. It is well known database inspection in which quality of the manufactures is judged in such a way as to compare the picture data with the graphic data.

A photo mask used for lithography for manufacturing semiconductor and a file format of CAD data for describing pattern of reticle are generally formed for the graphic form drawing equipment only. The fault inspection equipment carries out the database inspection in accordance with the following procedure. In the fault inspection equipment, reference picture is made to form from the CAD data. Comparison is made between the reference picture and the picture that is measured actually. In the database inspection, the file of the CAD data is treated, however, it is necessary to convert the format thereof for the inspection.

There is difference between data space resolution of the fault inspection equipment and that of the graphic form drawing equipment. There is difference between coordinate system such as position of origin and so forth of the fault inspection equipment and that of the graphic form drawing equipment. As for such differences, it is possible relatively easy to convert the differences in such a way as technique proposed by, for instance, the Japanese Patent Application Laid Open No. SHO 61-022624. However, besides the above matters, there is the following problem caused by the fact that delimiting method of CAD data for the graphic form drawing equipment is different from the delimiting method of data for the fault inspection equipment.

Firstly, explanation is made to carry out in connection with difference of delimiting method of the region of the data. In many cases, for the graphic form drawing equipment, the photo mask and the reticle are made to draw while being divided into a plurality of regions of the data. This unit of division is, of course, characteristic unit of data of the graphic form drawing equipment. In the side of the fault inspection equipment, part of the photo mask and the reticle is made to cut off to process as a frame (partial picture) by measure of some kind. Size of the cutting off becomes size of, for instance, 512×512 pixels while taking into account application for general picture processing system. However, the unit of the cutting off is characteristic unit of data of the fault inspection equipment.

Next, problems are made to enumerate that occur caused by difference of a way of delimiting of the region of the data.

In the data for the graphic form drawing equipment, the data is capable of being expressed as one graphic form, while in some cases, the same data strides across boundary existing between frames in the data of the fault inspection equipment. In these cases, the graphic form is divided into a plurality of graphic forms. Also, in some cases, repetitive pattern which is expressed as one repetitive region in the data of the graphic form drawing equipment is divided into a plurality of repetitive region in the data of the fault inspection equipment.

In the same case as above, in the data of the graphic form drawing equipment, in spite of the graphic form and/or the repetitive region which is not necessary to divide into a plurality of data within the frame of the fault inspection equipment, in some cases, the data can not help being divided because the data strides across characteristic boundary of the region of the data of the graphic form drawing equipment.

Further, in the CAD data for the graphic form drawing equipment, there is the case where large graphic form is divided into small basic graphic form, for instance, into quadrilaterals from drawing characteristic and/or limit of the data format in addition to the limit of the data region in the aforementioned graphic form drawing equipment. At the time of drawing of electric beam, this division is necessary, however, at the time of inspection, this division is not necessary. In the Japanese Patent Application Laid-Open No. HEI 03-152541, technique for consolidating a plurality of graphic forms into one is proposed. However, there is a large limit in that application is made to execute to only graphic forms with the same shape.

Furthermore, in the fault inspection equipment, as for compression of the CAD data which is subjected to a great deal of repetitions of the pattern, there is a fear that effect of compression decreases largely, when the repetitive region is divided caused by the boundary of the frame. Consequently, compression method of the CAD data for the fault inspection equipment is necessary to look at again.

Until now, the aforementioned points were not at stake. However, since nowadays explosive increase of data size occurs in OPC mask and so forth, there is the problem that the aforementioned points can not be ignored in that data-volume increases and processing speed deteriorates. Accordingly, it should be considered sufficiently.

### SUMMARY OF THE INVENTION

The present invention has been made in consideration of the above mentioned problems. It is an object of the present invention is to provide graphic data conversion method and data conversion apparatus in which disadvantage of the above described prior art is made to eliminate, as well as unprepared increase of data-volume does not occur and deterioration of processing speed of the fault inspection equipment caused by unnecessary region division is prevented even though the CAD data of the graphic form drawing equipment is made to convert into the graphic data for the fault inspection equipment.

A graphic data conversion method of the present invention has a configuration in which CAD data for a graphic form drawing equipment that is formed in such a way as to divide a region of data, which CAD data is made to convert into graphic data for a fault inspection equipment, particularly, in order to achieve the aforementioned object, graphic data which indicates the whole original graphic form is made to generate while unifying graphic data whose region is divided in the CAD data, thereafter, graphic data for the fault inspection equipment is made to generate from the aforementioned unified graphic data while matching a division-region which is determined by a file format for the fault inspection equipment.

According to such a configuration, the graphic form is made to optimize to the division-region that is determined by the file format for the fault inspection equipment. The graphic form thus optimized is capable of being output in spite of condition of division of the region of the data within the CAD data. Division of the graphic form is not carried out in the division-region for the fault inspection equipment. The data for prescribing divided portion of the graphic form that becomes unnecessary is not required. Compact data-volume is realized. Further, it is possible to carry out high speed processing operation of the fault inspection equipment for performing fault detection while referring to the graphic data, because the unnecessary data is removed.

Further, an extended division-region is made to set on the larger side than a division-region that is determined by a file format of the fault inspection equipment, then graphic data for the fault inspection equipment is made to generate to the extended division-region.

In this case, the graphic data included in the extended division-region on the larger side than the division-region which is determined by the file format of the fault inspection equipment is made to provide to the fault inspection equipment, therefore, error is allowed on its position determination of the fault inspection equipment at the time of inspection. Further, since size of the division-region handled by the fault inspection equipment substantially increases. For that reason, the number of the graphic form decreases, which graphic form is divided caused by the fact that the graphic form strides over this division-region. Thus, on the whole, the number of the graphic form to be handled decreases, it is possible to realize relatively compact data-volume.

Furthermore, the graphic data generated to the division-region that is determined by the file format for the fault inspection equipment in such a way as described above or to the extended division-region on the larger side than the division-region is made to define again as quadrilateral collection.

In this case, the number of the graphic data increases by dividing the graphic data into quadrilaterals, however, since shape-definition is simplified, it is possible to reduce data quantity as a whole.

Moreover, when there is a repetitive pattern of the graphic data whose region is divided in the CAD data, graphic data of a repetitive pattern including the whole repetitions is made to generate while unifying the repetitive pattern of the graphic data whose region is divided in the CAD data, then, generating graphic data of a repetitive pattern for the fault inspection equipment from the graphic data while matching the division-region which is determined by the file format of the fault inspection equipment, thus it is possible to achieve the same object described-above.

In this case, the repetitive pattern of the graphic form is not divided in its division-region of the fault inspection equipment. Repeated unnecessary shape-definition data is removed. Compact data-volume is realized. Since the unnecessary data is removed, high speed processing operation is realized in connection with the fault inspection equipment.

Here, again, the extended division-region is made to set on the larger side than a division-region that is determined by the file format of the fault inspection equipment, followed by generating the graphic data of the repetitive pattern for the fault inspection equipment while setting the extended division-region.

For that reason, error is allowed in connection with its position determination of the fault inspection equipment at the time of inspection. Further, since size of the division-region handled by the fault inspection equipment substantially increases. For that reason, the number of the repetitive pattern decreases, which repetitive pattern is divided caused by the fact that the repetitive pattern strides over this division-region. Thus, on the whole, the number of the repetitive pattern to be handled decreases, it is possible to realize relatively compact data-volume.

Furthermore, the graphic data of the repetitive pattern for the fault inspection equipment is made to generate to the division-region which is determined by the file format for the fault inspection equipment or to the extended division-region on the larger side in such a way as described-above, subsequently, judging existence of an extended division-region having graphic data of a common repetitive pattern, followed by registering the graphic data of the repetitive pattern as the graphic data of the extended division-region when the extended division-region does not exist, that has the graphic data of the common repetitive region, while when the extended division-region already exists, that has the graphic data of the common repetitive region, a storage destination of the graphic data of the common repetitive pattern is made to register in spite of the graphic data of the repetitive pattern. According to this measure, it is possible to realize more compact data-volume.

In this case, repeated registration of the graphic data with the same repetitive pattern is prevented, thus the data-volume is lightened.

The graphic data conversion apparatus of the present invention adopts a configuration comprising CAD data read-in means for inputting the CAD data, graphic form unification means for generating graphic data expressing the whole original graphic form while unifying the graphic data whose region is divided in the CAD data, graphic form division means for generating graphic data for the fault inspection equipment from the graphic data unified by the graphic form unification means while matching the division-region which is determined by a file format for the fault inspection equipment, and data output means for outputting the graphic data divided by the graphic form division means to either the fault inspection equipment or data storage means.

The graphic data conversion apparatus is suitable to be placed in the CAD system as part of the CAD system, further, is suitable to be placed in the fault inspection equipment as part of the fault inspection equipment, furthermore the graphic data conversion apparatus is suitable to be provided singly against the CAD system and/or the fault inspection equipment independently. According to such a configuration, it enables the graphic form that is restored to its original state to be output while optimizing for the region of the data, which is determined by the file format for the fault inspection equipment regardless of division condition of the region in the CAD data. Accordingly, there occurs no chance that the graphic form is divided within the division-region of the fault inspection equipment. Accordingly, the data-volume becomes compact because the data is removed on its unnecessary one that prescribes division section of the graphic form. Further, since the unnecessary data is removed, high speed operation of the fault inspection equipment is materialized in such a way as to carry out fault inspection while referring to this graphic data.

The graphic data conversion apparatus can be provided with frame setting means for setting an extended division-region on the larger side than the division-region which is determined by a file format of the fault inspection equipment, and graphic form division means for generating graphic data for the fault inspection equipment while matching the extended division-region from the graphic data that is unified by the graphic form unification means.

According to such a configuration, the graphic data which is included in the extended division-region on the larger side than the division-region which is determined by the file format of the fault inspection equipment is provided to the fault inspection equipment, therefore, error is allowed in connection with position determination of the fault inspection equipment at the time of inspection. Further, since size of the division-region handled by the fault inspection equipment substantially increases. For that reason, the number of the repetitive pattern decreases, which repetitive pattern is divided caused by the fact that the repetitive pattern strides over this division-region. Thus, on the whole, the number of the repetitive pattern to be handled decreases, it is possible to realize relatively compact data-volume.

Furthermore, the graphic data conversion apparatus can be provided with polygon division means for dividing graphic data of polygon within the extended division-region that is divided by the graphic form division means into quadrilateral collection.

In such a configuration, when original shape of the graphic form is another polygon, the number of the graphic form substantially preserved as data increases by dividing the graphic data into the quadrilateral. However, in the case of quadrilateral, information of the shape-definition is very simple. Accordingly, even though the number of the graphic form to be preserved increases, it is possible to certainly reduce the whole quantity of data.

Moreover, the graphic data conversion apparatus of the present invention comprises repetitive region unification means for generating graphic data of a repetitive pattern including the whole repetitions while unifying repetitive patterns of graphic data whose region is divided in the CAD data, repetitive region division means for generating graphic data of repetitive pattern for the fault inspection equipment while matching a division-region which is determined by a file format for the fault inspection equipment from the graphic data generated by the repetitive region unification means, and data output means for outputting the graphic data of the repetitive pattern divided by the repetitive region division means to either the fault inspection equipment or data storage means. According to such a configuration, it is possible to achieve the same object described-above.

In such a configuration, there occurs no chance that the repetitive patterns of the graphic form are divided in the division-region of the fault inspection apparatus, thus, the data-volume becomes compact because repeated unnecessary shape-definition data is removed. Further, the unnecessary data is removed, thus high speed processing operation of the fault inspection equipment is materialized.

Also in such a configuration, there can be provided with frame setting means for setting an extended division-region on the larger side than the division-region which is determined by a file format of the fault inspection equipment, and repetitive region division means for generating graphic data of repetitive pattern for the fault inspection equipment while matching an extended division-region which is set by the frame setting means from the graphic data generated by the repetitive region unification means.

For that reason, error is allowed in connection with position determination of the fault inspection equipment at the time of inspection. Further, since size of the division-region handled by the fault inspection equipment substantially increases. For that reason, the number of the repetitive pattern decreases, which repetitive pattern is divided caused by the fact that the repetitive pattern strides over this division-region. Thus, on the whole, the number of the repetitive pattern to be handled decreases, it is possible to realize relatively compact data-volume.

Still moreover, the graphic data conversion apparatus is suitably provided with interframe repetitive information registration means for registering graphic data of a repetitive pattern as graphic data of an extended division-region when the extended division-region that has graphic data of common repetitive pattern does not exist while judging existence the extended division-region having the graphic data of the common repetitive pattern, and reference template setting means for registering storage destination of graphic data of common repetitive pattern in stead of graphic data of repetitive pattern when the interframe repetitive information registration means judges that the extended division-region already exists, that has the graphic data of common repetitive pattern;

According to such a configuration, there occurs no chance that the graphic data of the same repetitive patterns are registered repeatedly, therefore, more compact data-volume is achieved.

As the concrete configuration of the most effective graphic data conversion apparatus, following graphic data conversion apparatus is proposed, in which there are provided with CAD data read-in means for inputting the CAD data, graphic form unification means for generating graphic data expressing the whole original graphic form while unifying the graphic data whose region is divided within the CAD data, repetitive region unification means for generating graphic data of a repetitive pattern including the whole repetitions while unifying repetitive patterns of graphic data whose region is divided within the CAD data, frame setting means for setting an extended division-region on the larger side than the division-region which is determined by a file format of the fault inspection equipment, graphic form division means for dividing the graphic data unified by the graphic form unification means at the extended division-region, polygon division means for dividing graphic data of polygon within the extended division-region that is divided by the graphic form division means into quadrilateral collection, repetitive region division means for generating graphic data of repetitive pattern for the fault inspection equipment while matching an extended division-region which is set by the frame setting means from the graphic data generated by the repetitive region unification means, interframe repetitive information registration means for registering graphic data of a repetitive pattern as graphic data of an extended division-region when the extended division-region that has graphic data of common repetitive pattern does not exist while judging existence the extended division-region having the graphic data of the common repetitive pattern, reference template setting means for registering storage destination of graphic data of common repetitive pattern in stead of graphic data of repetitive pattern when the interframe repetitive information registration means judges that the extended division-region already exists, that has the graphic data of common repetitive pattern, and data output means for outputting the graphic data divided by the polygon division means and the data set by the interframe repetitive information registration means and the reference template setting means to either the fault inspection equipment or data storage means.

According to such a configuration, wasteful information pertinent to the graphic form and/or the repetitive pattern is removed effectively, thus the data-volume becomes compact and high speed processing operation of the fault inspection equipment is achieved in high dimension.

### BRIEF DESCRIPTION OF THE DRAWINGS

FIG. 1 is a block diagram illustrating outline of a configuration of graphic data conversion apparatus of one embodiment to which graphic data conversion method of the present invention is applied;

FIG. 2 is a function block diagram without line of function simplified, which function is achieved by CPU and/or ROM arranged at the graphic data conversion apparatus of the embodiment;

FIG. 3 is a flowchart illustrating outline of processing that is executed by CPU arranged at the graphic data conversion apparatus of the embodiment;

FIG. 4 is a continued flowchart from FIG. 3 illustrating outline of processing executed by CPU arranged at the graphic data conversion apparatus of the same embodiment;

FIG. 5 is a continued flowchart from FIG. 4 illustrating outline of processing executed by CPU arranged at the graphic data conversion apparatus of the same embodiment;

FIG. 6 is a continued flowchart from FIG. 5 illustrating outline of processing executed by CPU arranged at the graphic data conversion apparatus of the same embodiment;

FIG. 7 (a) is a conceptual view illustrating one example of graphic form that is incapable of being unified to quadrilateral;

FIG. 7 (b) is a conceptual view illustrating variation of data caused by unification of graphic form;

FIG. 7 (c) is a conceptual view illustrating example of graphic form expressed with MEBES format;

FIG. 8 (a) is a conceptual view illustrating one example of graphic form that is capable of being unified to quadrilateral;

FIG. 8 (b) is a conceptual view illustrating one example of graphic form that is incapable of being unified of repetitive region;

FIG. 9 (a) is a conceptual view illustrating variation of data caused by unification of repetitive region;

FIG. 9 (b) is a conceptual view illustrating one example of pixel that is ignored on the picture processing;

FIG. 10 is a conceptual view illustrating one example of relationship between extended frame and clipping frame;

FIG. 11 (a) is a conceptual view illustrating as example divided graphic form in clipping frame and/or extended frame;

FIG. 11 (b) is a conceptual view illustrating example of disassembly of polygon;

FIG. 12 (a) is a conceptual view illustrating example of disassembly depending on automatic processing;

FIG. 12 (b) is a conceptual view illustrating one example of template that is constituted with repetitive graphic form;

FIG. 12 (c) is a conceptual view illustrating one example of template that is not constituted with repetitive graphic form;

FIG. 13 (a) is a conceptual view illustrating one example of content of template;

FIG. 13 (b) is a conceptual view illustrating example of reference of the template; and

FIG. 13 (c) is a conceptual view illustrating one example of the template that is referred to.

### DETAILED DESCRIPTION OF THE PREFERRED EMBODIMENT

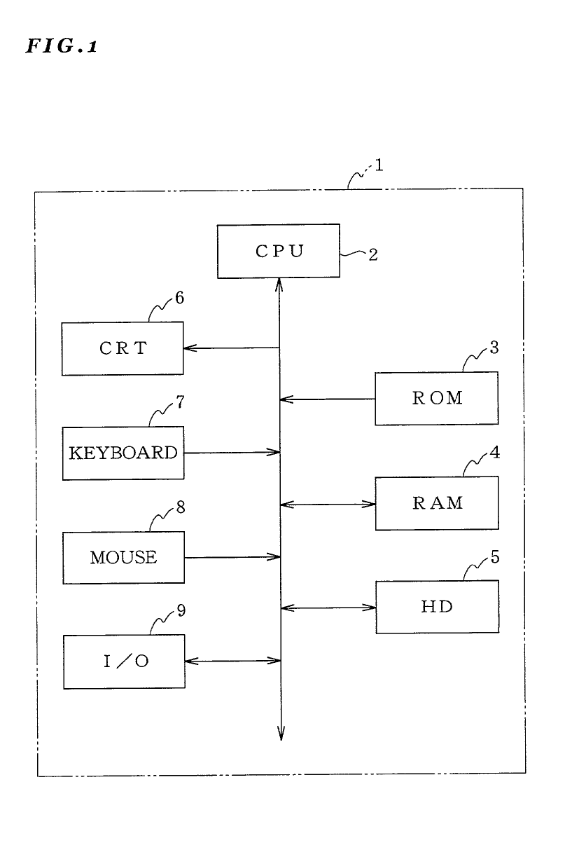

A preferred embodiment of the present invention will be described in detail below with reference to accompanying drawings. FIG. 1 is a block diagram illustrating outline of configuration of graphic data conversion apparatus of one embodiment to which graphic data conversion method of the present invention is applied.

As illustrated in FIG. 1, the graphic data conversion apparatus 1, in rough outline, comprises a CPU 2 for processing of operation, a ROM 3 in which control program thereof and so forth are stored, a RAM 4 used for temporary storage of data, a hard disk 5 to be data storage medium, a keyboard 7 and a mouse 8 as data input means, and a CRT 6 used for display of graphic data and so forth. Further the graphic data conversion apparatus 1 is provided with interface 9 for connecting to external device.

As for principal section of hardware configuration, that is the same as general personal computer, and/or control device for controlling the CAD system or the fault inspection equipment. Accordingly, it is easy to incorporate this data conversion apparatus 1 as part of the CAD system or the fault inspection equipment therein.

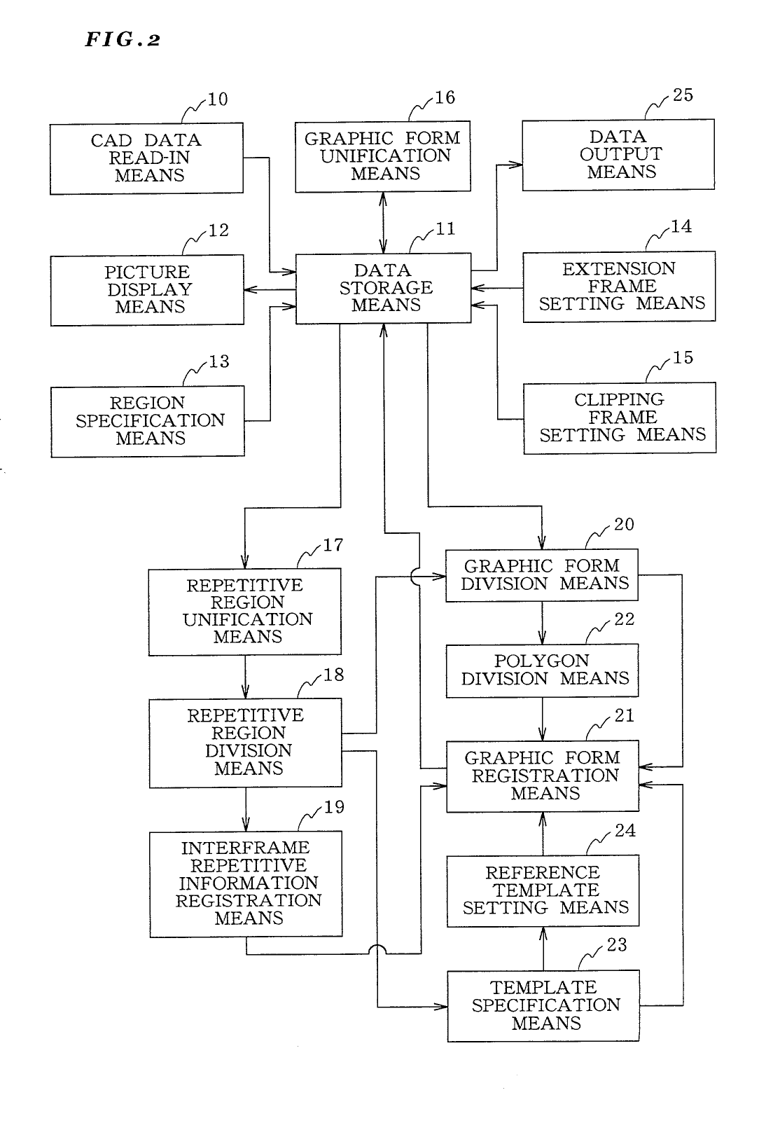

FIG. 2 is a functional block diagram illustrating simplified outline of function achieved by control program of the CPU 2 and the ROM 3 stationed at the graphic data conversion apparatus 1.

Firstly, explanation is made to carry out simply about outline of each function. CAD data read-in means 10 substantially corresponds to the interface 9 of FIG. 1, thus it is used for input of the CAD data. Further, when this data conversion apparatus 1 and the CAD system are integrally constituted, it is possible to input the CAD data directly from common hard disk 5 to the data conversion apparatus 1 and the CAD system.

The input CAD data is held in data storage means 11, namely, the CAD data is held in the RAM 4 illustrated in FIG. 1 as the data of job-object. Various kinds of processing are carried out to this data.

Picture display means 12 is constituted by the CRT 6 in FIG. 1. Each function of region specification means 13, extension frame setting means 14 and clipping frame setting means 15 is capable of being achieved depending on internal processing with the CPU 2 or hand control operation of an operator. In the case of the hand control operation of the operator, the keyboard 7 and the mouse 8 are employed as part of the region specification means 13, the extension frame setting means 14 and the clipping frame setting means 15.

Graphic form unification means 16 analyzes the CAD data held in the data storage means 11 for unifying a plurality of graphic forms into one graphic form while employing coordinate values of graphic form in the CAD data. In this case, one graphic form is divided into a plurality of graphic forms that should be one graphic form by its nature, caused by limits and so forth of the data format of the graphic form drawing equipment. Thus, the data of the unified graphic form is replaced by previous CAD data within the data storage means 11.

Repetitive region unification means 17 analyzes the CAD data held in the data storage means 11 for unifying a plurality of repetitive region in to one repetitive region while employing coordinate values of graphic form in the CAD data. In this case, one repetitive region is divided into a plurality of repetitive regions that should be one repetitive region by its nature, caused by limits and so forth of the data format of the graphic form drawing equipment. Thus, the data of the unified repetitive region is replaced by previous CAD data within the data storage means 11.

The extension frame setting means 14 sets larger region (extension frame) than a frame size on the occasion of picture processing, namely, that is larger than a division-region decided depending on the file format for the fault inspection equipment. It is disposal for compensating error that occurs caused by the picture processing or matching of position of the fault inspection equipment and/or for suppressing unnecessary division of graphic data.

The clipping frame setting means 15 sets a clipping frame that is the maximum range of the graphic form preserved in each extension frame as the graphic data from among graphic forms sticking out the extension frame that are falls in this category of the extension frame.

This extension frame and the clipping frame are one kind of an extended division-region.

A repetitive region division means 18 divides repetitive region on the basis of the region of size specified beforehand, for instance, an extension frame and overlapped condition among the regions.

In the case that the repetitive region is overlapped with the extension frame and exists in the clipping frame, the data pertinent to this repetitive region is registered on interframe repetitive information list by an interframe repetitive information registration means 19.

Further, although the repetitive region exits within the clipping frame, the repetitive region is not overlapped with the extension frame. In this case, the repetitive region is ignored as being unrelated to information within the extension frame.

In the case that expression of repetition with extension frame as unit is insufficient, more larger region is made to specify depending on a template specification means 23. Repetitive region is made to extract from among the larger regions. Thus description of repetition with this region as unit is carried out. Furthermore, in the case that the same repetitive pattern appears at a plurality of locations in the whole graphic data, since it is waste that whenever data of the same repetitive pattern and/or repetition pitch is made to preserve, destination of reference of data is made to set depending on a reference template setting means 24. Then common data is made to set in such a way as to utilize the common data while referring to it as it is.

Moreover, in some cases, the repetitive region is overlapped with the extension frame and the repetitive region sticks out the clipping frame. In such a case, part of the graphic form that exists within the extension frame or within the clipping frame is treated as independent graphic form pertinent to the extension frame. This independent graphic form is divided by a graphic form division means 20 with extension frame as boundary or with clipping frame as boundary. Further, if the divided graphic form is quadrilateral (the smallest parts component treated by CAD) to be fundamental component, it is registered in an interframe graphic form list within this extension frame as the independent graphic form pertinent to the extension frame by a graphic form registration means 21. Furthermore, if the divided graphic form is not the quadrilateral, the divided graphic form is further divided into unit of the quadrilateral by polygon division means 22, then divided unit of the quadrilateral is registered in the interframe graphic form list in the same way described above.

The graphic form registration means 21 replaces the final data obtained by the aforementioned each processing with the previous CAD data within the data storage means 11. The final data is the interframe repetitive information list and the interframe graphic form list in every respective frames, information of repetition extracted from specified region by the template specification means 23 and information pertinent to destination of reference of the information and so forth. Finally, the data within the data storage means 11 is preserved in the hard disk 5 to be non-volatile storage means, or the data is output to the fault inspection equipment and so forth as it is through the interface 9 to be the data output means 25.

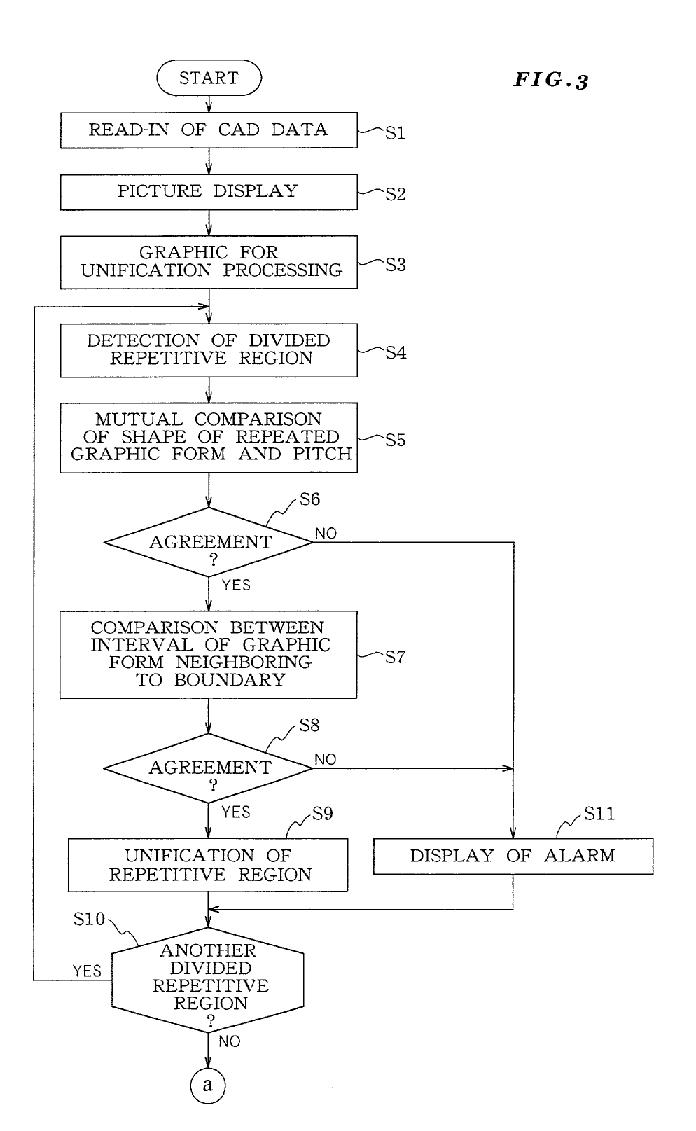

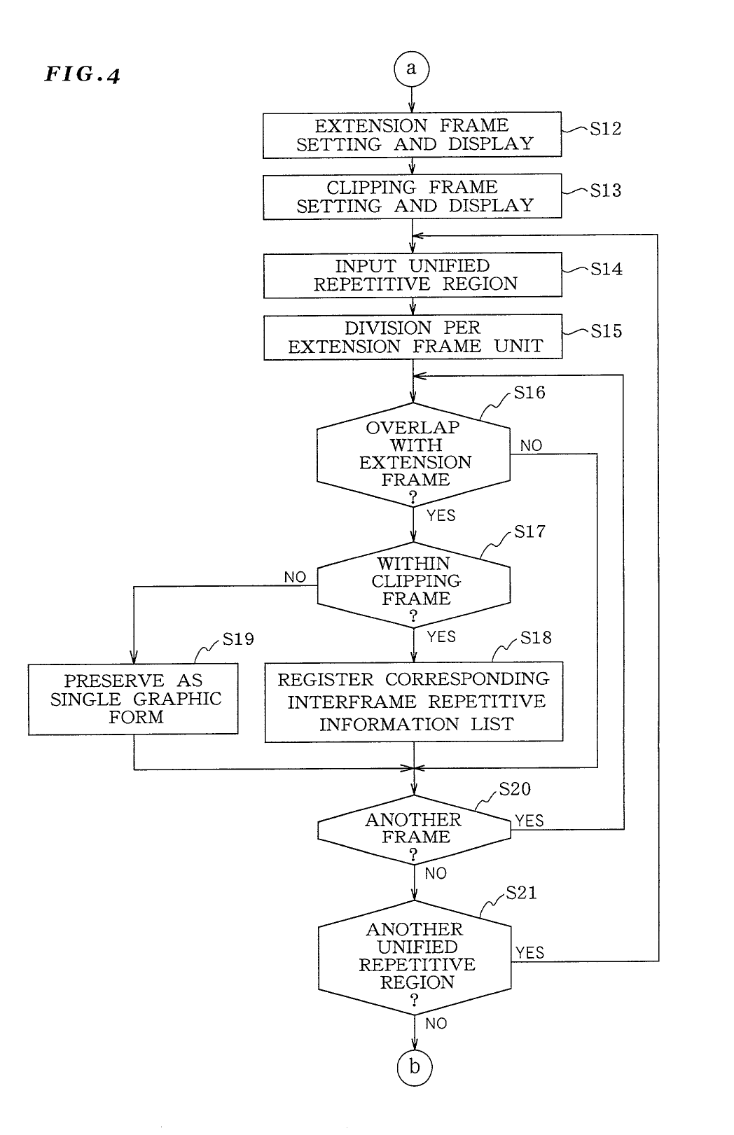

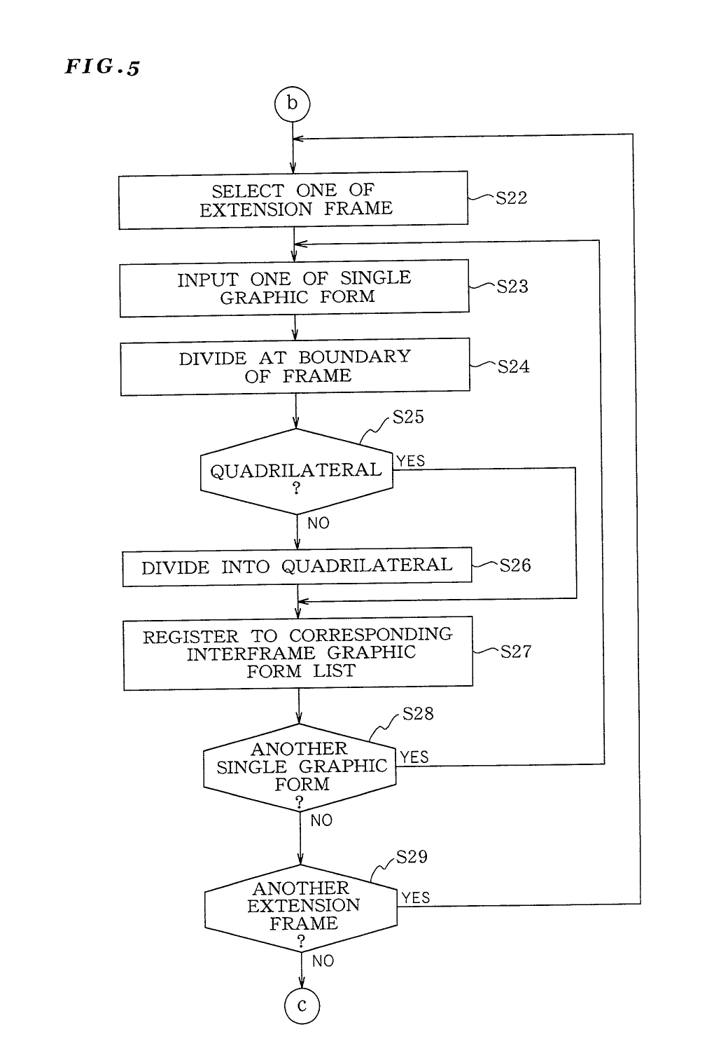

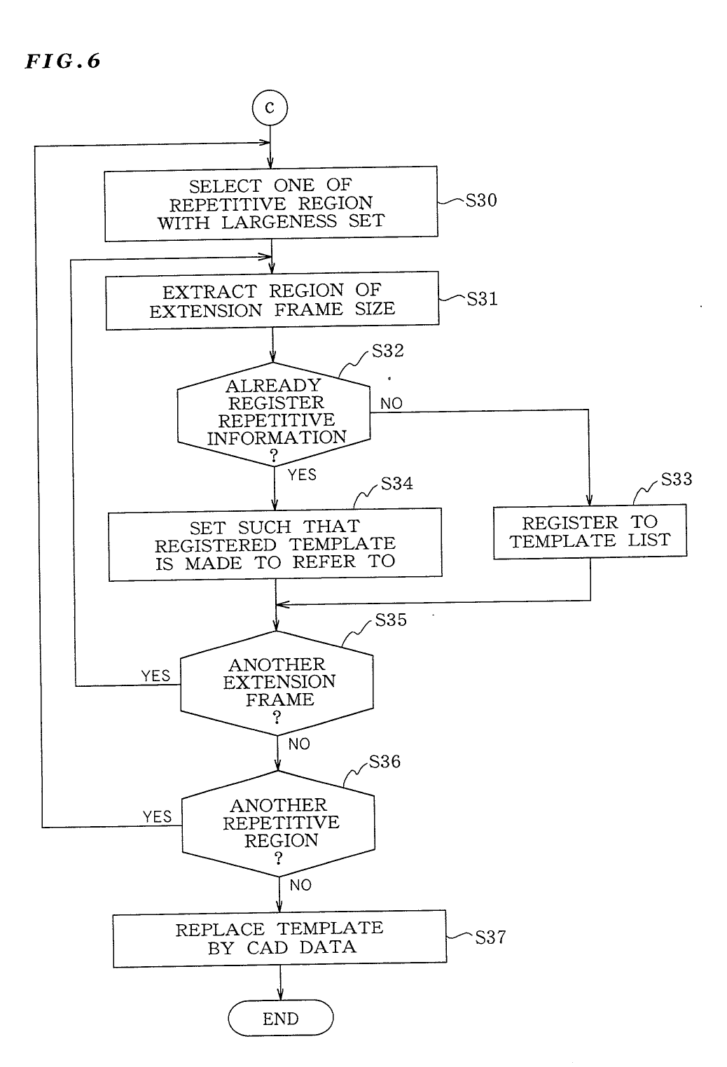

These are outline of the configuration. Substantial processing operation according to the CPU 2 of the graphic data conversion apparatus 1 will be explained in detail while referring to flowchart of FIG. 3 to FIG. 6 below.

The CPU 2 inputs graphic data generated by the CAD system to the data storage means 11 through the CAD data read-in means 10. This CAD data is made to select as job-object of the data conversion (STEP s1). Picture thereof is made to display on the picture display means 12 (STEP s2). Here, the CRT 6 is employed as the picture display means 12, however, it is also suitable to utilize liquid crystal projector and so forth. Magnification of display is capable of being set arbitrarily by the user. The CAD data is generally expressed by the use of vertex coordinate data, length of a side, and direction of a side of graphic form of parts. However, various divisions occur in the graphic form and the repetitive region expressed by the use of the inherent format of the CAD data.

Accordingly, the CPU 2 to be the graphic form unification means 16 analyzes these data for restoring the divided graphic forms to the original shape by its nature while integrating divided graphic forms which are divided in the CAD data (STEP s3).

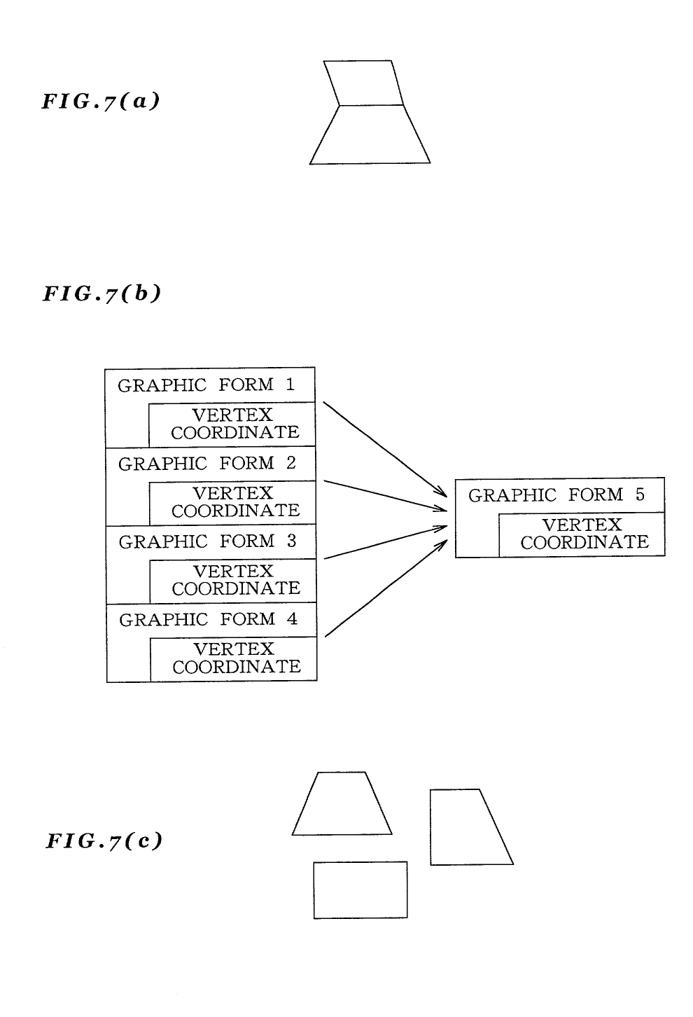

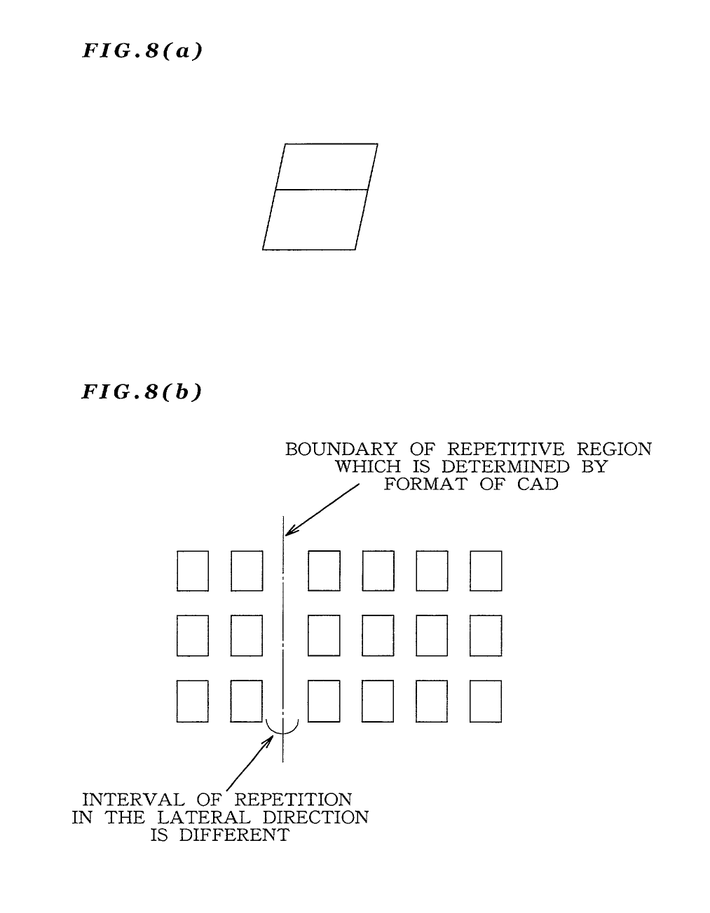

On this occasion, it is suitable to select the divided graphic forms manually depending on rubber band and click manipulation of the mouse using the keyboard 7 and the mouse 8 that constitute the region specification means 13 while referring to the picture of the picture display means 12 by the operator. In such a case, the CPU 2 examines the divided graphic form whether or not it becomes a quadrilateral after unification while observing it from angle of corner of selected neighboring graphic form. As example illustrated in FIG. 8 (a), if the divided graphic forms become a quadrilateral after unification, the CPU 2 unifies them. Further, as example illustrated in FIG. 7 (a), if the divided graphic forms do not become a quadrilateral after unification, the CPU 2 allows to stand as it is. Then the CPU 2 notifies warning message that the graphic forms cannot be unified to the operator through the picture display means 12. The unification of the graphic forms means that, for instance, as illustrated in FIG. 7 (b) a plurality of quadrilateral data becomes one quadrilateral data in terms of the CAD data.

On the other hand, the graphic forms are made to unify automatically depending on the CPU 2 as the graphic form unification means 16. In such a case, the CPU 2 examines whether the divided graphic forms become a quadrilateral after unification about the whole combinations of the quadrilaterals whose side is contact with each other. The CPU 2 selects the combinations that become a quadrilateral to unify with automatic processing.

MEBES format (MEBES Software Manual, Etec Systems, Inc. 1998) is used at the most frequently as the CAD data format of an electronic beam graphic form drawing equipment. In the MEBES format, as example of FIG. 7(c) , the whole graphic forms are expressed with quadrilaterals whose upper side and lower side are horizontal. Accordingly, there is a case that it is possible to judge whether or not the graphic forms are unified by the use of only name of the graphic form such as for example between a rectangle and a trapezoid, or between parallel quadrilaterals. Further, in the MEBES format, if the upper side and the lower side are horizontal, the graphic forms contact only in the lateral direction or in the vertical direction, the coordinate of contacted angle agrees with each other, and the angular sum of the contacted angles is 180 degrees, as example of FIG. 8 (a) ,it becomes a quadrilateral invariably.

Generally, judgement whether or not the graphic forms are capable of being unified is made to carry out on the basis of following procedure. Firstly, Judgement is made to carry out whether or not the coordinate of two corners agrees with each other. Further, judgement is made to carry out whether or not angular sum of the contacted corners is 180 degrees pertinent to the graphic forms whose coordinate of two corners agree with each other. If the angular sum is 180 degree, these graphic forms are capable of being unified. Accordingly, it is possible to execute automatic unification of the graphic forms depending on the CPU 2 while applying such a condition.

Thus, after the whole graphic forms, which are capable of being unified, are unified. The CPU 2 detects sets of neighboring repetitive region which are divided into a plurality of repetitive regions on the basis of instructions of the operator by the region specification means 13 or on the basis of the CAD data. In such a case, one repetitive region by its nature is divided into a plurality of repetitive regions caused by the limit of the CAD data format for the graphic form drawing equipment or drawing characteristic of the electronic beam and so forth (STEP s4).

Subsequently, the CPU 2 as the repetitive region unification means 17 causes detected shape of the respective graphic forms in the repetitive region and repetition pitch in respective repetitive regions to be compared with each other between the regions (STEP s5). Thus, the CPU 2 discriminates whether or not both the shape of the graphic forms and the pitch of repetition agree with each other (STEP s6). If there is disagreement in either one, both is not the repetitive region with the same characteristic. Therefore, it is impossible to unify these repetitive regions.

Consequently, in such a case, warning message that it is impossible to unify the repetitive regions is made to notify to the operator through the picture display means 12 (STEP s11).

While, when both the shape of the graphic form and the repetition pitch agree with each other, the CPU 2 as the repetitive region unification means 17 further examines interval of the graphic forms that are positioned at both sides while putting the boundary of the regions therebetween, which regions are divided caused by the format of the CAD, as illustrated in FIG. 8 (b) (STEP s7). The CPU 2 discriminates whether or not this interval agrees with the repetition pitch of the graphic form in the respective regions described-above (STEP s8).

In the case that this interval does not agree with the repetition pitch, it is impossible to describe using single repetition pitch as one graphic data while arranging these regions. Accordingly, the CPU 2, like the above case, warning message that it is impossible to unify the repetitive regions is made to notify to the operator through the picture display means 12 (STEP s11).

On the other hand, when the interval of the graphic forms positioned at both sides while putting the boundary of the regions therebetween agrees with the repetition pitch of the graphic forms, since it is possible to describe with one graphic data and single repetition pitch while arranging these regions, the CPU 2 as the repetitive region unification means 17 unifies these repetitive regions (STEP s9).

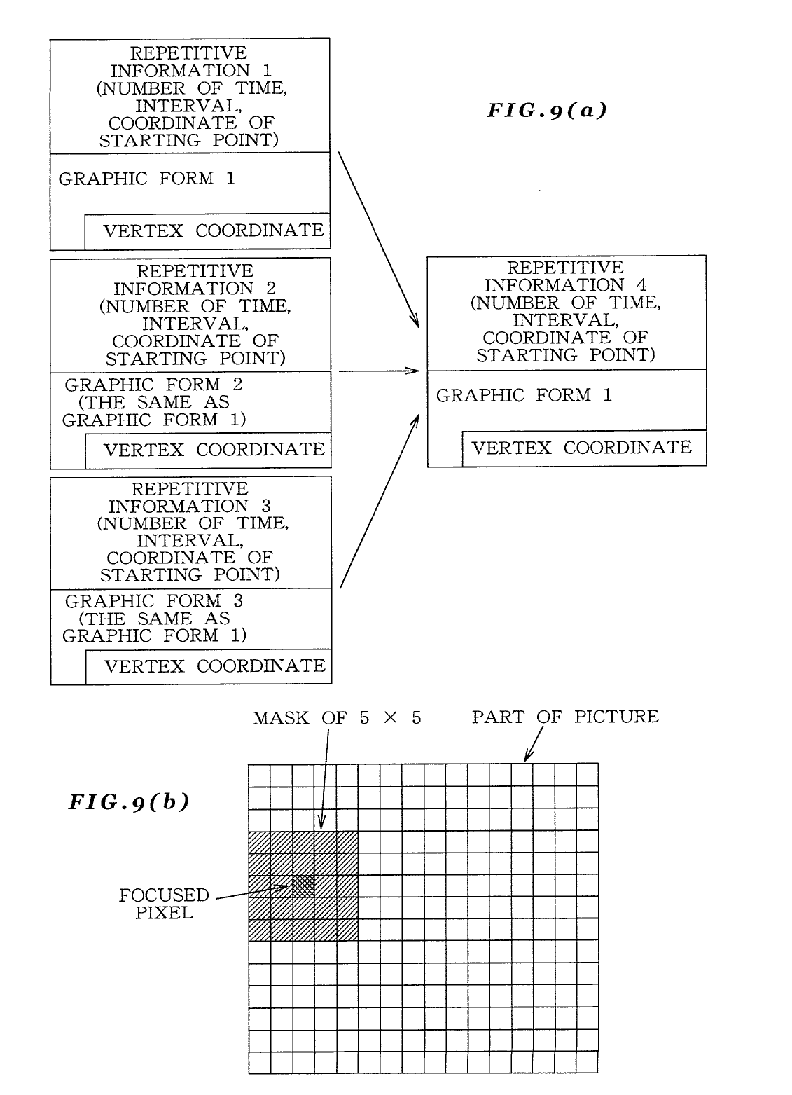

The unification of the repetitive region is that the repetitive information consisting of repetition starting point, repetition end point and the number of times of repetition of one side of repetition graphic form in the CAD data as illustrated in FIG. 9 (a) is made to modify, while the other repetitive information is made to eliminate. Namely, here, shape data of one graphic form as the origin and its position, and repetition pitch for arranging the graphic form of reproduction and its number of times of repetition are necessary.

Next, the CPU 2 as the repetitive region unification means 17 ascertains whether or not divided repetitive region exists elsewhere in the CAD data that is input therein at the present processing time (STEP s10). If there is divided repetitive region elsewhere in the CAD data, the aforementioned same processing is made to execute repeatedly, thus the whole repetitive regions capable of being unified are made to unify (STEP s4 to STEP s10).

According to this processing, the whole limit matters are released in terms of data description occurring caused by circumstances of the CAD system. The graphic forms within the CAD data are replaced to the original shape by its nature. Further, property of discontinuity which occurs in the repetitive region is removed.

Processing described below is carried out to the graphic data and the repetitive information within the data storage means 11, which data and information are replaced to the original shape.

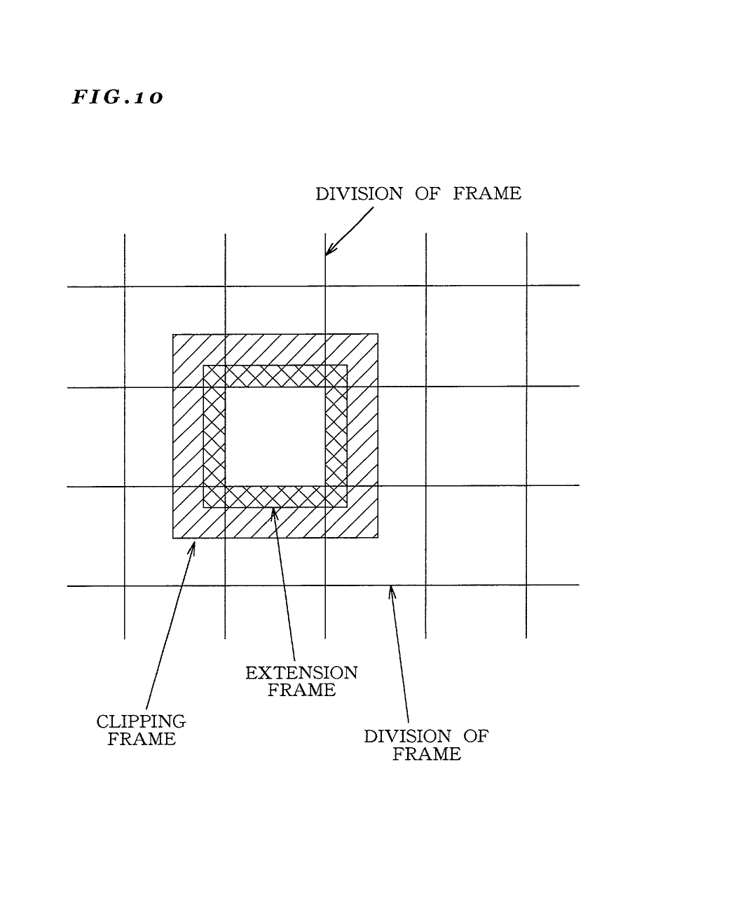

The CPU 2 ensures the frame size to be an object of the picture processing in such a way that the frame size become a little larger than actual state while taking into account pixels that may become ineffective caused by the picture processing, in addition to the frame to which actual picture processing is subjected, namely in addition to the frames of the division-region determined depending on the data format of the fault inspection equipment. For instance, as illustrated in FIG. 9 (b), in the case of implementation of mask processing of 5×5, it is necessary to obtain region corresponding to two pixels in the upper and lower direction and in the right and left direction from the focused pixel, therefore, it is necessary to ignore corresponding two pixels from the edge of the picture. On this occasion, for instance as illustrated in FIG. 10, further wide region is made to ensure as an object of the picture processing while taking into account error of position matching of the equipment (STEP s12) . Thus, the frame is extension frame that is ensured more widely against the division-region determined depending on the data format of the fault inspection equipment. This extension frame is set in every respective frame, therefore, the extension frames are overlapped mutually.

The CPU 2 as the clipping frame setting means 15 sets more wider region including the aforementioned extension frame as the clipping frame (STEP s13). One example of relationship between the extension frame and the clipping frame is indicated in FIG. 10. The mutual clipping frames are overlapped in the same way as the extension frames. These extension frames and the clipping frames are one type of extended division-region.

Subsequently, the CPU 2 as the repetitive region division means 18 selects one of the repetitive regions unified by the repetitive region unification means 17 described-above (STEP s14). The CPU 2 divides this repetitive region by the extension frame unit (STEP s15). Then, the CPU 2 as the repetitive region division means 18 discriminates whether or not at least part of the repetition graphic form overlaps with inside region of the extension frame while giving attention to one extension frame thereof (STEP s16) , and also discriminates whether or not the whole repetition graphic forms are in place in the clipping frame accompanying this extension frame (STEP s17).

Here, part of repetition graphic form overlaps with the inside region of the extension frame and it is in place in the clipping frame accompanying this extension frame. Namely in such a case, both results of discrimination of STEP s16 and STEP s17 are “YES”. In this case, the CPU 2 as the interframe repetitive information registration means 19 judges that the whole repetition graphic forms are the graphic data pertinent to the extension frame. The CPU 2 registers the repetitive information to the interframe repetitive information list of the extension frame (STEP s18).

Thus, although the repetition graphic form sticks out the extension frame, that is treated as the graphic form of the single extension frame in terms of the graphic form that is in place in the clipping frame as the whole thereof. Thus, the data which expresses the shape thereof is not stored while overlapping with another extension frame, therefore, being useful for mitigation of the whole data-volume.

Further, although the repetition graphic form exists in the clipping frame, the repetition graphic form does not overlap with the region of inside of the extension frame, namely, result of discrimination of STEP s16 becomes “NO”, in such a case, the CPU 2 as the repetitive region division means 18 judges that these repetition graphic forms are not related with the extension frame. The CPU 2 does not execute registration processing to the interframe repetitive information list.

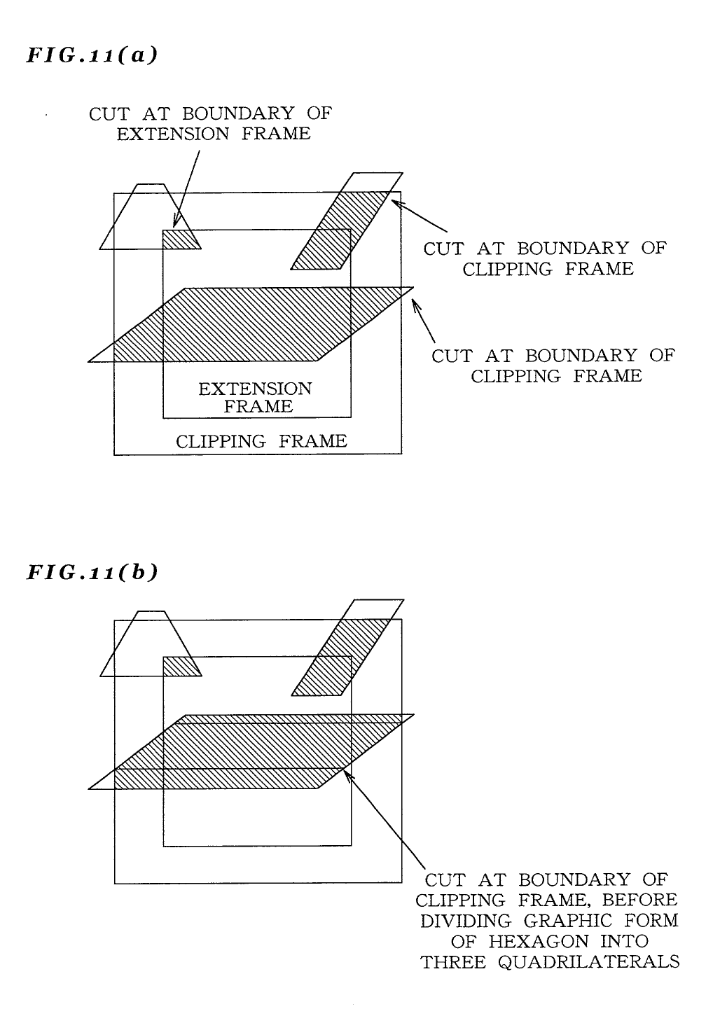

Furthermore, when the graphic form exists within the extension frame, and the graphic form sticks out the clipping frame, namely when the result of discrimination of STEP s16 is “YES” and the result of discrimination of STEP s17 is “NO”, the CPU 2 as the repetitive region division means 18 preserves the graphic form as a single graphic form (STEP s19) . Further, this graphic form is subjected to processing of the graphic form division means 20 described later finally. This graphic form is divided at the boundary of the clipping frame or at the boundary of the extension frame as illustrated in FIG. 11 (a). Further, the divided graphic forms within the frame is subjected to processing of the polygon division means 22, followed by being divided into unit of a quadrilateral, as illustrated in FIG. 11 (b), thus the graphic form divided into unit of the quadrilateral is registered in the interframe graphic form list corresponding to the extension frame.

Thus, the CPU 2 which has completed the processing to one extension frame discriminates whether or not extension frame that is not yet dealt with remains in the selected repetitive region with processing of STEP s14 (STEP s20). When the extension frame remains still to be dealt with, the CPU 2 gives attention to next extension frame afresh, then the same processing as described-above is made to execute repeatedly to the extension frame (STEP s16 to STEP s20).

Then, processing to the whole extension frames belonging to the repetitive region selected by processing of STEP s14 is completed, with the result that result of discrimination of STEP s20 becomes “NO”. The CPU 2 discriminates whether or not another already-unified repetitive regions that are not selected yet as the job-object regarding the processing of STEP s14 exist (STEP s21). If another already-unified repetitive region exists, the same processing as described-above is made to execute repeatedly with the already-unified repetitive region as new job-object (STEP s14 to STEP s21).

Result of discrimination becomes “NO” finally in connection with STEP s21. Processing of division for region is completed to the whole repetitive region thus unified. The CPU 2 as the repetitive region division means 18 becomes no relation with this loop.

Subsequently, the CPU 2 as the graphic form division means 20 selects one of extension frames (STEP s22). The CPU 2 gives attention to one of single graphic forms existing within this extension frame (STEP s23). Here, the single graphic form is one which is set as single graphic form in the processing of STEP s19 described-above. Namely, the single graphic form includes repetition graphic form existing within the extension frame and repetition graphic form sticking out the clipping frame.

Accordingly, the CPU2 as the graphic form division means 20 divides the single graphic form to which the CPU 2 gives attention at the boundary of the clipping frame (STEP s24). Then, the CPU 2 discriminates whether or not divided graphic form on the inside, namely shape of the graphic form within the clipping frame is a quadrilateral (STEP s25). When the graphic form is a quadrilateral, the CPU 2 registers information of the graphic form on the interframe graphic form list corresponding to the extension frame (STEP s27).

While result of discrimination of STEP s25 becomes “NO”, namely, when the graphic form which is divided at the boundary of the clipping frame is not a quadrilateral, further, the CPU 2 as the polygon division means 22 divides this graphic form, as illustrated in FIG. 11 (b), into unit of constitution of a quadrilateral as being the smallest part component (STEP s26). In the same way as described-above, the CPU 2 registers the quadrilateral on the interframe graphic form list corresponding to the extension frame (STEP s27).

Here, when the operator instructs course of division in the processing of STEP s26, for instance, the operator generates straight line depending on drag manipulation of the mouse 8 which constitutes part of the region specification means 13, followed by dividing the graphic form along the line.

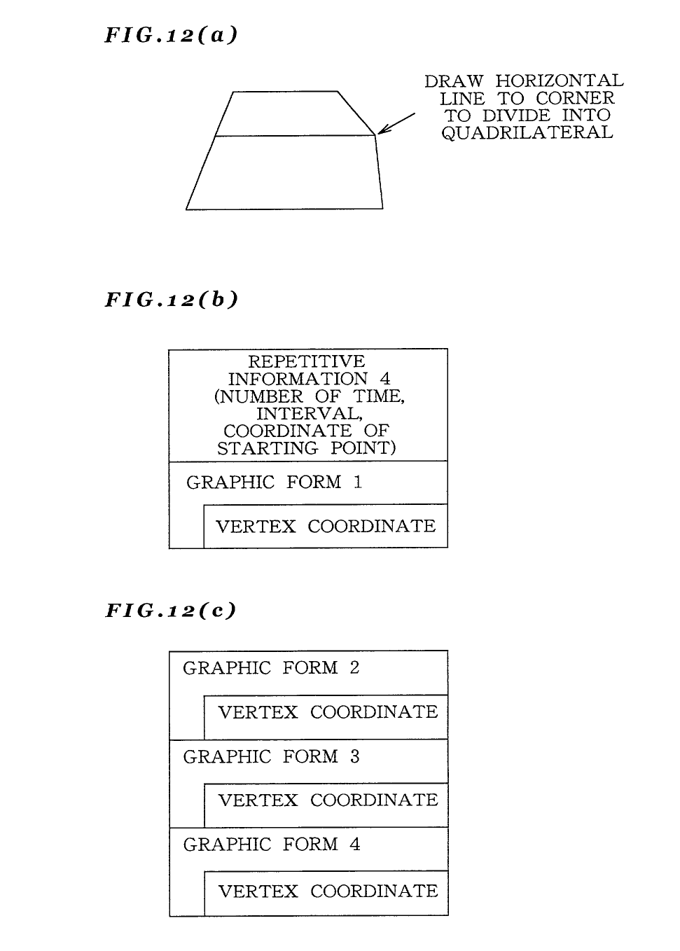

Further, when the graphic form is made to divide automatically, for instance, as illustrated in FIG. 12 (a), corner of the graphic form is made to detect depending on internal processing of the CPU 2, followed by drawing horizontal line in every corner, then, the graphic form is made to divide along the line.

Thus, the CPU 2 which ends the processing to one graphic form to which the CPU 2 gives attention discriminates whether or not another single graphic form exists within this extension frame (STEP s28) . If another single graphic form exists, the CPU 2 gives attention to the graphic form afresh, thus the same processing as described-above is made to execute repeatedly (STEP s23 to STEP s28).

Then, the processing is completed in connection with the whole single graphic forms included in the extension frame selected by the processing of STEP s22. Result of discrimination becomes “NO” in connection with STEP s28. Subsequently, the CPU 2 discriminates whether or not another extension frame exists that is not selected yet as the job-object in the processing of STEP s22 (STEP s29). If another extension frame exists, the same processing as described-above is made to execute repeatedly with the extension flame as new job-object (STEP s22 to STEP s29).

The result of discrimination becomes “NO” in connection with STEP s29 finally. Detection of the single graphic form, and division of the graphic form and the processing of registration are completed to the whole extension frames. Then the CPU 2 as the graphic form division means 20 as well as the polygon division means 22 separates from the role of the loop processing.

Subsequently, the CPU 2 as a template specification means 23 extracts a repetitive region with predetermined largeness that is set larger than the extension frame or the clipping frame depending on instructing manipulation from the operator using the region specification means 13 such as the keyboard 7 and/or the mouse 8 and so forth. The CPU 2 sets part thereof as the template of the repetitive pattern. This is the processing for extracting repetitive information of the repetitive region that is not registered in the interframe repetitive information list because the repetitive region sticks out the extension frame and/or the clipping frame in the processing of STEP s16 to STEP s20 described-above.

Here, when the operator sets the template, the operator employs the region specification means 13 such as the keyboard 7 and/or the mouse 8 and so forth as the template specification means 23. The operator specifies a rectangular region with appropriate largeness. This rectangular region is registered on the list of the template as the template.

Further, when the template is made to register automatically, the CPU 2 searches for repetitive region that is N times (N is integer given beforehand) the size of the template while employing coordinate value in the CAD data on the basis of the size of the template with largeness given beforehand (STEP s30). The CPU 2 as the template specification means 23 cuts down the region with the template size from the region to be taken as the template (STEP s31). Appropriate size of the template is size of the extension frame and so forth.

Here, when the template itself is constituted by the repetition graphic form, information of the template becomes, for instance, that illustrated in FIG. 12 (b). While when the template itself is not constituted by the repetition graphic form, information of the template becomes, for instance, that illustrated in FIG. 12 (c).

Next, the CPU 2 discriminates whether or not repetitive information of the template that is required newly this time is already registered as the template (STEP s32). If the repetitive information of the template is not registered yet, the repetitive information is made to register on the template list (STEP s33).

Further, when result of discrimination becomes “YES” in connection with STEP s32, namely, when the repetitive information of the template is already registered as the template, the CPU 2 as the reference template setting means 24 does not register the information to the template repeatedly. The CPU 2 establishes the setting in such a way as to refer to existing template to which the same information is registered (STEP s34).

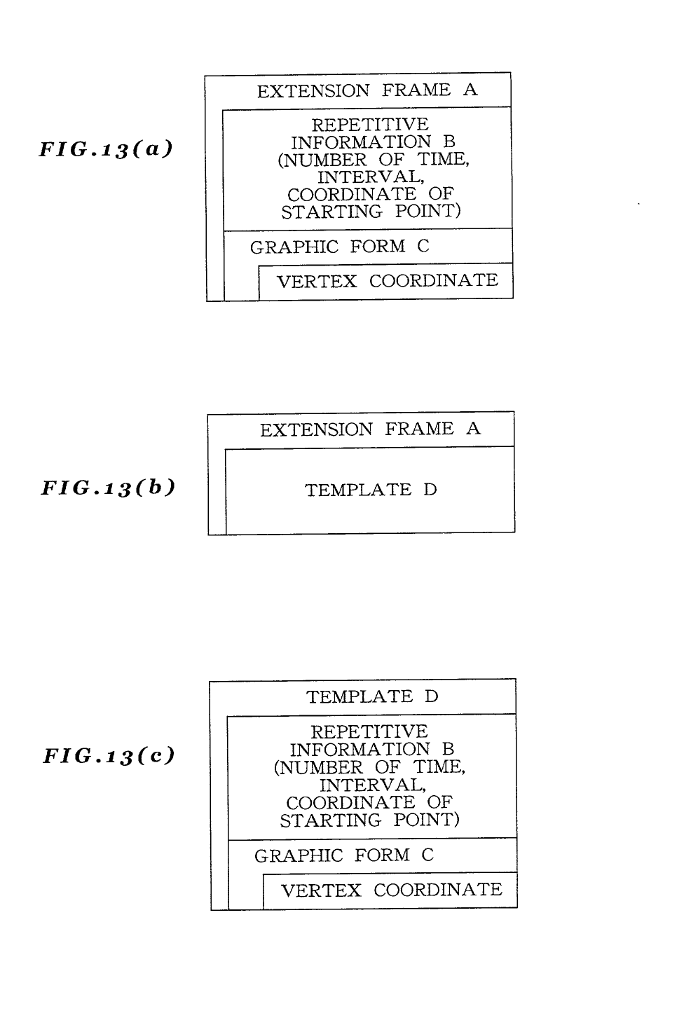

For instance, if an extension frame is expressed using repetitive information as FIG. 13 (a), and the template as illustrated in FIG. 13 (c) is set within the repetitive region including such extension frame, and the template is registered in the template list, the repetitive information of this extension frame is, for instance, simplified as FIG. 13 (b) thus, content of the template of FIG. 13 (c) is referred to. Furthermore, D is a value indicating the destination of storage of the template.

Thus, the CPU 2 which registers one newly template or sets reference destination of the existing template discriminates whether or not another extension frame to become template size exists in the repetitive region selected at this time (STEP s35). If another extension frame exists, the same processing described-above is made to execute repeatedly with this extension frame as template (STEP s31 to STEP s35).

Further, the processing is completed pertaining to the whole extension frames included in the repetitive region selected by the processing of STEP s30, thus result of discrimination of STEP s35 becomes “NO”. The CPU 2 discriminates whether or not another repetitive region exists therein that is not selected yet as the job-object on the processing of STEP s30 (STEP s36). If another repetitive region exists, the same processing described-above is made to execute repeatedly with the repetitive region as the new job-object (STEP s30 to STEP s36).

Then, result of discrimination becomes “NO” in connection with STEP s36 finally. When registration or setting of reference of the template is completed to the whole repetitive regions, the CPU 2 as the template specification means 23 and/or the reference template setting means 24 separates from the role thereof. The CPU 2 as a graphic form registration means 21 stores in the data storage means 11 while replacing data generated until now, namely, the interframe repetitive information list in every frame, the interframe graphic form list and the template information and so forth with the CAD data, thus, the processing ends pertinent to data conversion (STEP s37).

This data is capable of being preserved as it is. Further, it is possible to output to the fault inspection equipment and so forth through the interface 9 to become the data output means 25 if necessary.

As described-above, according to the graphic data conversion apparatus 1 of the present embodiment, the graphic data within the CAD data and/or the data of the repetitive pattern is restored to the original state of the original repetitive pattern including the original shape and/or the whole repetitions once. Then, the restored data is cut down while matching the division-region appropriate to the file format of the fault inspection equipment or matching to the region of the extension frame a little larger than this division-region afresh, therefore, heedless division of the graphic data is not carried out within the division-region (frame) in terms of the data format of the fault inspection equipment. Accordingly, the number of the graphic forms that should be treated actually at the side of the fault inspection equipment decrease remarkably in comparison with the conventional apparatus. The memory capacity to be secured decreases. Comparison processing to the measurement data that is necessary for the fault detection work according to the fault inspection equipment is simplified. Thus, the fault detection work is carried out speedy.

Further, in some cases, there exists repetitive pattern sticking out the extension frame. However, although the repetitive pattern is one which sticks out the extension frame, as for the repetitive pattern which is in place in the clipping frame accompanying the extension frame, such repetitive pattern can be registered as the graphic form pertinent to the extension frame. Furthermore, as for the extension frame with the same repetitive pattern, information on the graphic form is made to obtain while referring to the template, therefore, shape of the original graphic form which constitutes the repetitive pattern is not registered repeatedly corresponding to a plurality of extension frames. Thus, it is possible to remarkably reduce capacity of memory at the time of preservation of data. Actual data compression effect is improved.

Furthermore, the extension frame and the clipping frame are set on the larger side in comparison with division-region that agrees with the file format of the fault inspection equipment. Accordingly, error is allowed in connection with its position determination of the fault inspection equipment at the time of inspection. Even though it might cause interference with position determination, it is unnecessary to carry out comparison with the measured data while reading out data of neighboring frame specially. Thus, high speed processing operation of the fault inspection equipment is achieved. The graphic form and/or the repetitive pattern are divided depending on the extension frame and the clipping frame on the larger side in comparison with the picture processing frame of the fault inspection equipment, the graphic form and the repetitive pattern are divided at a small rate stochastically.

Namely, unprepared division of the graphic form and repetitive pattern do not occur, thus the number of the graphic form that are dealt with decrease substantially, it is possible to make capacity of data more compact.

The single graphic form is finally divided into a quadrilateral. The single graphic form is preserved as the graphic data of a quadrilateral. When original shape of the graphic form is another polygon, the number of the graphic form substantially preserved as data increases. However, in the case of quadrilateral, information of the shape-definition is very simple. Accordingly, even though the number of the graphic form to be preserved increases, it is possible to certainly reduce the whole quantity of data in comparison with the case that another polygon is made to preserve with shape-definition.

According to the graphic data conversion method and the graphic data conversion apparatus of the present invention, the graphic form is made to optimize to the division-region that is determined by the file format for the fault inspection equipment. The graphic form thus optimized is capable of being output in spite of condition of division of the region in the CAD data. Unprepared division of the graphic form is not carried out in the division-region of the fault inspection equipment. The data for prescribing divided portion of the graphic form that becomes unnecessary is not required. Compact data-volume is realized. Further, it is possible to carry out high speed processing operation of the fault inspection equipment for performing fault detection while referring to the graphic data, because the unnecessary data is removed.

Moreover, the extended division-region on the larger side is made to set than the division-region which is determined by the file format of the fault inspection equipment, followed by generating the graphic data for the fault inspection equipment while matching this extended division-region, therefore, error is allowed in connection with its position determination of the fault inspection equipment at the time of inspection. Further, since size of the division-region handled by the fault inspection equipment substantially increases. For that reason, the number of the graphic form decreases, which graphic form is divided caused by the fact that the graphic form strides over this division-region. Thus, on the whole, the number of the graphic form to be handled decreases, it is possible to realize relatively compact data-volume.

Further, the graphic data is made to divide up to unit of a quadrilateral finally to preserve. The shape-definition is simplified in connection with the graphic form. It is possible to reduce data quantity as a whole.

When repetitive pattern exists pertinent to graphic data whose region is divided in the CAD data, this repetitive region is made to unify in order to generate graphic data of the repetitive pattern including the whole repetition while unifying this repetitive pattern. Then, the graphic data of repetitive pattern for the fault inspection equipment is made to generate from this graphic data while matching the division-region that is determined by the file format of the fault inspection equipment. For that reason, the repetitive pattern of the graphic form is not divided within the division-region of the fault inspection equipment. Repeated unnecessary shape-definition data is removed. Compact data-volume is realized. Since the unnecessary data is removed, high speed processing operation is realized in connection with the fault inspection equipment.

Moreover, the extended division-region on the larger side is made to set than the division-region which is determined by the file format of the fault inspection equipment, followed by generating the graphic data of the repetitive pattern for the fault inspection equipment while matching this extended division-region, therefore, error is allowed in connection with its position determination of the fault inspection equipment at the time of inspection. Further, since size of the division-region handled by the fault inspection equipment substantially increases. For that reason, the number of the repetitive pattern decreases, which repetitive pattern is divided caused by the fact that the repetitive pattern strides over this division-region. Thus, on the whole, the number of the repetitive pattern to be handled decreases, it is possible to realize relatively compact data-volume.

Moreover, when the graphic data with common repetitive pattern exists, preservation of the repeated same data is avoided, and storage destination of the graphic data with common repetitive pattern registered. The registered common repetitive pattern is employed. It is possible to realize more compact data-volume.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-156579 (Filed on May 26th, 2000) including specification, claims, drawings and summary are incorporated herein by reference in its entirety.

What is claimed is:

1. A graphic data conversion method in which CAD data for a graphic form drawing equipment that is formed in such a way as to divide a region of data is made to convert into graphic data for a fault inspection equipment, comprising the step of:
generating graphic data which represents the whole original graphic form in such a way as to unify graphic data whose region is divided among said CAD data,
generating graphic data for said fault inspection equipment from said unified graphic data in such a way as to match a division-region which is determined by a file format for said fault inspection equipment.

2. A graphic data conversion method in which CAD data for a graphic form drawing equipment that is formed in such a way as to divide a region of data is made to convert into graphic data for a fault inspection equipment, comprising the steps of:
generating graphic data which represents the whole original graphic form, in such a way as to unify graphic data whose region is divided among said CAD data; and
generating graphic data for said fault inspection equipment from said generated graphic data in such a way as to match an extended division-region while setting said extended division-region on the larger side than a division-region which is determined by a file format of said fault inspection equipment.

3. A graphic data conversion method in which CAD data for a graphic form drawing equipment that is formed in such a way as to divide a region of data is made to convert into graphic data for a fault inspection equipment, comprising the steps of:
generating graphic data which represents the whole original graphic form in such a way as to unify graphic data whose region is divided among said CAD data;
setting an extended-division region on the larger side than a division-region which is determined by a file format of a fault inspection equipment;
dividing said generated graphic data at said extended division-region; and
redefining divided polygon graphic data within said extended division-region as quadrilateral collection.

4. A graphic data conversion method in which CAD data for a graphic form drawing equipment that is formed in such a way as to divide a region of data is made to convert into graphic data for a fault inspection equipment, comprising the steps of:
generating graphic data of a repetitive pattern containing the whole repetitions in such a way as to unify the repetitive pattern of graphic data whose region is divided among said CAD data; and
generating graphic data of the repetitive pattern for said fault inspection equipment from the graphic data in such a way as to match a division-region which is determined by a file format of said fault inspection equipment.

5. A graphic data conversion method in which CAD data for a graphic form drawing equipment that is formed in such a way as to divide a region of data is made to convert into graphic data for a fault inspection equipment, comprising the steps of:
generating graphic data of a repetitive pattern containing the whole repetitions in such a way as to unify the repetitive pattern of graphic data whose region is divided among said CAD data; and
generating graphic data of the repetitive pattern for said fault inspection equipment from said generated graphic data in such a way as to match an extended division-region while setting said extended division-region on the larger side than a division-region which is determined by a file format of said fault inspection equipment.

6. A graphic data conversion method in which CAD data for a graphic form drawing equipment that is formed in such a way as to divide a region of data is made to convert into graphic data for a fault inspection equipment, comprising the steps of:
generating graphic data of a repetitive pattern containing the whole repetitions in such a way as to unify the repetitive pattern of graphic data whose region is divided among said CAD data;
generating graphic data of the repetitive pattern for said fault inspection equipment from said generated graphic data in such a way as to match an extended division-region while setting said extended division-region on the larger side than a division-region which is determined by a file format of said fault inspection equipment;
judging existence of said extended division-region that has graphic data of a common repetitive pattern;
registering graphic data of repetitive pattern as the graphic data of said extended division-region when extended division-region which has the graphic data of said common repetitive pattern does not exist, while when the extended division-region which has the graphic data of said common repetitive region already exists, a storage-destination of the graphic data of said common repetitive pattern is made to register in spite of the graphic data of said repetitive pattern.

7. A graphic data conversion apparatus in which CAD data for a graphic form drawing equipment that is formed in such a way as to divide a region of data is made to convert into graphic data for a fault inspection equipment comprising:
CAD data read-in means for inputting the CAD data;
graphic form unification means for generating graphic data which represents the whole original graphic form in such a way as to unify the graphic data whose region is divided among said CAD data;
graphic form division means for generating graphic data for said fault inspection equipment from the graphic data unified by said graphic form unification means in such a way as to match a division-region which is determined by a file format for the fault inspection equipment; and
data output means for outputting the graphic data divided by said graphic form division means to either said fault inspection equipment or data storage means.

8. A graphic data conversion apparatus in which CAD data for a graphic form drawing equipment that is formed in such a way as to divide a region of data is made to convert into graphic data for a fault inspection equipment comprising:
CAD data read-in means for inputting the CAD data;
graphic form unification means for generating graphic data which represents the whole original graphic form in such a way as to unify the graphic data whose region is divided among said CAD data;
frame setting means for setting an extended division-region on the larger side than a division-region which is determined by a file format of said fault inspection equipment;
graphic form division means for generating graphic data for said fault inspection equipment from the graphic data unified by said graphic form unification means in such a way as to match said extended division-region; and
data output means for outputting the graphic data divided by said graphic form division means to either said fault inspection equipment or data storage means.

9. A graphic data conversion apparatus in which CAD data for a graphic form drawing equipment that is formed in such a way as to divide a region of data is made to convert into graphic data for a fault inspection equipment comprising:
CAD data read-in means for inputting the CAD data;
graphic form unification means for generating graphic data which represents the whole original graphic form in such a way as to unify the graphic data whose region is divided among said CAD data;
frame setting means for setting an extended division-region on the larger side than a division-region which is determined by a file format of said fault inspection equipment;
graphic form division means for dividing the graphic data unified by said graphic form unification means at said extended division-region;
polygon division means for dividing graphic data of polygon within the extended division-region which is divided by said graphic form division means into quadrilateral collection; and
data output means for outputting the graphic data divided by said polygon division means to either said fault inspection equipment or data storage means.

10. A graphic data conversion apparatus in which CAD data for a graphic form drawing equipment that is formed in such a way as to divide a region of data is made to convert into graphic data for a fault inspection equipment comprising:
CAD data read-in means for inputting the CAD data;
repetitive region unification means for generating graphic data of a repetitive pattern containing the whole repetitions in such a way as to unify the repetitive pattern of the graphic data whose region is divided among said CAD data;
repetitive region division means for generating graphic data of repetitive pattern for said fault inspection equipment from the graphic data generated by said repetitive region unification means in such a way as to match a division-region which is determined by a file format for the fault inspection equipment; and
data output means for outputting the graphic data of the repetitive pattern generated by said repetitive region division means to either said fault inspection equipment or data storage means.

11. A graphic data conversion apparatus in which CAD data for a graphic form drawing equipment that is formed in such a way as to divide a region of data is made to convert into graphic data for a fault inspection equipment comprising:
CAD data read-in means for inputting the CAD data;
repetitive region unification means for generating graphic data of a repetitive pattern containing the whole repetitions in such a way as to unify the repetitive pattern of the graphic data whose region is divided among said CAD data;
frame setting means for setting an extended division- region on the larger side than a division- region which is determined by a file format of said fault inspection equipment;
repetitive region division means for generating graphic data of repetitive pattern for said fault inspection equipment from the graphic data generated by said repetitive region unification means in such a way as to match said extended division-region which is set by said frame setting means; and
data output means for outputting the graphic data of the repetitive pattern generated by said repetitive region division means to either said fault inspection equipment or data storage means.

12. A graphic data conversion apparatus in which CAD data for a graphic form drawing equipment that is formed in such a way as to divide a region of data is made to convert into graphic data for a fault inspection equipment comprising:
CAD data read-in means for inputting the CAD data;
repetitive region unification means for generating graphic data of a repetitive pattern containing the whole repetitions in such a way as to unify the repetitive pattern of the graphic data whose region is divided among said CAD data;
frame setting means for setting an extended division-region on the larger side than a division-region which is determined by a file format of said fault inspection equipment;
repetitive region division means for generating graphic data of repetitive pattern for said fault inspection equipment from the graphic data generated by said repetitive region unification means in such a way as to match said extended division-region which is set by said frame setting means;
interframe repetitive information registration means for judging existence of the extended division-region which has the graphic data of the common repetitive pattern, in cases where there does not exists said extended division-region which has graphic data of common repetitive pattern, said graphic data of the repetitive pattern is made to register as the graphic data of the extended division-region concerned;
reference template setting means for registering storage-destination of graphic data of common repetitive pattern in stead of graphic data of repetitive pattern when said interframe repetitive information registration means judges that the extended division-region already exists, that has the graphic data of common repetitive pattern; and
data output means for outputting the data set by said interframe repetitive information registration means and said reference template setting means to either said fault inspection equipment or data storage means.

13. A graphic data conversion apparatus in which CAD data for a graphic form drawing equipment that is formed in such a way as to divide a region of data is made to convert into graphic data for a fault inspection equipment comprising:
CAD data read-in means for inputting the CAD data;
graphic form unification means for generating graphic data which represents the whole original graphic form in such a way as to unify the graphic data whose region is divided among said CAD data;
repetitive region unification means for generating graphic data of a repetitive pattern containing the whole repetitions in such a way as to unify the repetitive pattern of the graphic data whose region is divided among said CAD data;
frame setting means for setting an extended division-region on the larger side than a division-region which is determined by a file format of said fault inspection equipment;
graphic form division means for dividing the graphic data unified by said graphic form unification means at said extended division-region;
polygon division means for dividing graphic data of polygon within the extended division-region which is divided by said graphic form division means into quadrilateral collection;
repetitive region division means for generating graphic data of repetitive pattern for said fault inspection equipment from the graphic data generated by said repetitive region unification means in such a way as to match said extended division-region which is set by said frame setting means;
interframe repetitive information registration means for judging existence of the extended division-region which has the graphic data of the common repetitive pattern, in cases where there does not exists said extended division-region which has graphic data of common repetitive pattern, said graphic data of the repetitive pattern is made to register as the graphic data of the extended division-region concerned;
reference template setting means for registering storage-destination of graphic data of common repetitive pattern in stead of graphic data of repetitive pattern when said interframe repetitive information registration means judges that the extended division-region already exists, that has the graphic data of common repetitive pattern; and
data output means for outputting the graphic data divided by said polygon division means and the data set by said interframe repetitive information registration means and said reference template setting means to either said fault inspection equipment or data storage means.
